(19) United States
(12) Patent Application Publication
(10) Pub. No.: US 2026/0209540 A1
(43) Pub. Date: Jul. 23, 2026

(54) IMPROVED CONDUCTIVE INK COMPOSITIONS

(71) Applicant: ELECTRONINKS INCORPORATED, Austin, TX (US)

(72) Inventors: S. Brett WALKER, Austin, TX (US); Melburne LEMIEUX, El Dorado Hills, CA (US); K.L. Iresha Sampathi PERERA, Austin, TX (US); Garret MCKERRICHER, Austin, TX (US); Ron CHERTAKOVSKY, Austin, TX (US); Scott Soung Jae LEE, Austin, TX (US)

(73) Assignee: ELECTRONINKS INCORPORATED, Austin, TX (US)

(21) Appl. No.: 19/144,497

(22) PCT Filed: Dec. 29, 2023
(86) PCT No.: PCT/US2023/086353

§ 371 Date: Jun. 29, 2025

Related U.S. Application Data
(60) Provisional application No. 63/477,806, filed on Dec. 29, 2022.

(51) Int. Cl. C09D 11/52; C09D 11/033; C09D 11/037; C09D 11/102; C09D 11/108

(52) U.S. Cl. CPC C09D 11/52; C09D 11/033; C09D 11/037; C09D 11/102; C09D 11/108

(57) ABSTRACT

Improved conductive ink compositions and methods of making and using the conductive ink compositions are provided. The improved conductive ink compositions include a silver complex formed by mixing a silver carboxylate, specifically a silver decanoate isomer, and at least one dissolving agent, in particular where the at least one dissolving agent comprises a terpene, a terpenoid, or a combination thereof. The silver carboxylate of the subject ink compositions is decarboxylated at a temperature of 250° C. or less. The conductive ink compositions preferably further comprise a non-acid stabilizer and optionally further comprise an acid stabilizer and/or an adhesion promoter. Methods of making conductive structures, including methods wherein the disclosed compositions are applied to a suitable substrate by various techniques, are also provided.

### CROSS-REFERENCE TO RELATED APPLICATIONS

This application claims the benefit of U.S. Provisional Application No. 63/477,806, filed on Dec. 29, 2022, the disclosure of which is incorporated herein by reference in its entirety.

### FIELD OF THE INVENTION

The present disclosure relates generally to novel ink compositions and their methods of preparation and use. More particularly, the present disclosure relates to improved particle-free ink compositions comprising silver carboxylates that form conductive structures at low temperature.

### BACKGROUND OF THE INVENTION

The electronics, display, and energy industries rely on the production and use of coatings and patterns of conductive materials to form circuits on organic and inorganic substrates. Printed electronics offer an attractive alternative to conventional technologies by enabling the creation of large-area, flexible devices at low cost. There is a great need for high-conductivity materials with fine-scale features in modern electronics such as solar cell electrodes, flexible displays, radio frequency identification tags, antennas, and many more. In efforts to make these high-technology devices increasingly affordable, the substrates used typically have relatively little temperature resilience and require low processing temperatures to maintain integrity.

The vast majority of commercially produced conductive inks are specifically designed for inkjet, screen-printing, or roll-to-roll processing methods in order to process large areas with fine-scale features in short time periods. These inks have disparate viscosities and synthesis parameters. Particle-based inks are based on conductive metal particles, which are typically synthesized separately and then incorporated into an ink formulation. The resulting ink is then tuned for specific particle process.

Typically, precursor-based inks are based on thermally unstable precursor complexes that undergo reduction to a conductive metal upon heating. Prior particle- and precursor-based methods generally rely on high temperatures to form conductive coatings and thus may not be compatible with substrates that require low processing temperatures to maintain integrity. For example, silver compounds with carbamate or other relatively low molecular weight ligands (compared to polymer stabilizers) have been synthesized that decompose at temperatures near 150° C., yielding electrical conductivities approaching that of bulk silver. Unfortunately, even these temperatures can render the ink incompatible with many plastic and paper substrates commonly used in flexible electronic and biomedical devices.

International Publication No. WO2015/160938 provides conductive ink compositions, methods of production and use, and conductive structures prepared using the ink compositions. Among the ink compositions are examples comprising a silver carboxylate, at least one dissolving agent, and a catalyst that decarboxylates the silver carboxylate to form a conductive structure. The decarboxylation reaction can occur at low temperatures.

European Patent No. EP 3597707 B1 provides conductive ink compositions for inkjet or screen printing processes. The conductive ink compositions comprise a silver carboxylate, a terpene, and at least one carboxylic acid as a further component. The ink compositions can be used in methods for producing a pattern on a substrate.

International Publication Nos. WO2015/192248 A1 and WO2018/146617 A1 provide conductive ink compositions containing a silver carboxylate, a solvent, and a polymer binder.

Despite these and other advances in the field, there continues to be a need for particle-free conductive ink compositions with improved properties. Therefore, it is an object of the present invention to provide improved, stable, particle-free conductive ink compositions and methods for their preparation and use, in particular compositions that can form conductive structures at low temperatures and ideally without catalysts. It is also an object of the present invention to provide improved, stable, particle-free conductive ink compositions and methods for their preparation and use, wherein the compositions have considerable adhesion to a variety of substrates for a variety of purposes. Such purposes can include those involving epoxy molding compound (EMC), solder resist functionality, silver nanowire substrates (SNW), and so forth, with both thin and thick inkjet printing layers. Such conductive inks can be used on a variety of substrates to form conductive structures with superior physical, mechanical, and electrical properties. Further, it is an object of the present invention to provide improved, stable, particle-free conductive ink compositions and methods for their preparation and use, wherein the compositions have improved stability, even in the absence of acid stabilizers.

### SUMMARY OF THE INVENTION

The instant disclosure addresses these and other considerations by providing in one aspect a conductive ink composition comprising a silver complex formed by combining a silver decanoate, at least one dissolving agent, and a stabilizing agent, wherein the silver decanoate is decarboxylated at a temperature of 250° C. or less to form a conductive structure.

In some aspects, the techniques described herein relate to conductive ink compositions including: a silver decanoate; at least one dissolving agent; and at least one non-acid stabilizer; wherein the at least one dissolving agent includes a terpene, a terpenoid, or a combination thereof; and wherein the silver decanoate is decarboxylated at a temperature of 250° C. or less to form a conductive structure.

In some aspects, the techniques described herein relate to methods for making conductive structures, including: dissolving a silver decanoate in at least one dissolving agent to form a conductive ink composition, wherein the at least one dissolving agent includes a terpene, a terpenoid, or a combination thereof, and wherein the conductive ink composition further includes at least one non-acid stabilizer.

In some aspects, the techniques described herein relate to methods for making conductive ink compositions, including: dissolving a silver decanoate in at least one dissolving agent to form a conductive ink composition, wherein the at least one dissolving agent includes a terpene, a terpenoid, or a combination thereof, and wherein the conductive ink composition further includes at least one non-acid stabilizer.

### BRIEF DESCRIPTION OF THE DRAWINGS

FIG. 1 illustrates the stability of exemplary ink composition formulations of the disclosure.

FIG. 2 illustrates the stability of exemplary ink composition formulations of the disclosure.

FIG. 3 illustrates the stability of exemplary ink composition formulations of the disclosure.

FIG. 4 illustrates the stability of exemplary ink composition formulations of the disclosure.

### DETAILED DESCRIPTION OF THE INVENTION

Ink compositions derived from silver metal precursors have been described in PCT International Publication No. WO2013/096664A1, which is incorporated herein by reference in its entirety. Further conductive ink compositions are described, for example, in PCT International Publication No. WO2015/160938A1, which is also incorporated herein by reference in its entirety. Although these ink compositions are advantageously free of metallic particles, they typically require a catalyst, for example an amine-containing catalyst, to facilitate decarboxylation of the silver complexes, and thus formation of the conductive metallic structures at low temperatures.

Additional improved conductive ink compositions are described in U.S. Patent Application No. 63/316,949, filed on Mar. 4, 2022, U.S. Patent Application No. 63/370,343, filed on Aug. 3, 2022, and U.S. Patent Application No. 63/384,202, filed on Nov. 17, 2022, each of which is incorporated herein by reference in its entirety. Those ink compositions comprise a silver decanoate and at least one dissolving agent. In some embodiments, the ink compositions comprise at least one «-branched silver decanoate isomer. In some embodiments, the ink compositions comprise an adhesion promoter comprising a reactive silane or an epoxide. In preferred embodiments, the previous improved conductive ink compositions do not require a catalyst to decarboxylate the silver complex.

Disclosed herein are improved conductive ink compositions comprising a silver decanoate and at least one dissolving agent, wherein the compositions form conductive metallic structures at low temperatures. The compositions preferably further comprise a stabilizing agent, preferably a non-acid stabilizing agent, for example a β-diketone stabilizing agent. The stabilizing agents of the instant compositions are preferably soluble in the ink compositions and can enable an increase in metal loading, for example, from about 0.5% to about 3%, without a decrease in conductivity of conductive metallic structures that are formed from the ink compositions at low temperatures on a variety of substrates. Furthermore, ink compositions comprising the stabilizers are stable at 30° C., or even 40° C., without visible precipitation/plating over long periods, and the viscosities of the ink compositions are suitable for use in standard inkjet printheads, including Samba and Ricoh-type printheads. By employing lower decomposition temperatures and reduced tack times to form the conductive structures, the improved conductive ink compositions are compatible with more substrates that do not require high processing temperatures to maintain integrity. Furthermore, the methods for making the conductive ink compositions are both simple and result in a high yield of conductive structures.

The conductive ink compositions may possess low viscosity so that they are compatible with a broad range of patterning techniques, including slot die coating, spin coating, roll-to-roll printing, including gravure, flexography, rotary screen printing, screen-printing, aerosol jet printing, inkjet printing, airbrushing, Mayer rod coating, flood coating, 3D printing, and electrohydrodynamic printing. In particular, the inks are compatible with inkjet printing, dip coating, and spray coating. The patterned features may be highly conductive at room temperature and achieve bulk conductivity upon decomposing at mild temperatures (e.g., in some cases at less than about 100° C.). Finally, the ink compositions may remain stable at room temperature for months without particle precipitation.

Accordingly, conductive ink compositions (also referred to as “conductive inks” or “inks”) have been created for printing highly conductive features at low temperatures. Such inks may be stable, particle-free, and suitable for a wide range of patterning techniques. In some embodiments, a “particle-free” ink is one that does not include any particles at a diameter of greater than about 10 nm. In some embodiments, a “particle-free” ink is one that has less than about 1% particles, preferably less than about 0.1% particles. Silver salts are employed in the inks as a precursor material, which ultimately yields the silver in the conductive silver coatings, lines, or patterns. Any suitable silver precursor may be used.

In one aspect, a conductive ink composition includes a silver complex formed by mixing a silver carboxylate and at least one dissolving agent. In preferred embodiments, the silver carboxylate is soluble in the dissolving agent. Solubility, as known to one of ordinary skill, is the property of a substance, such as a silver carboxylate, to dissolve in a solvent, such as a dissolving agent. In some embodiments, the silver complex is first applied to a substrate. In some embodiments, the silver carboxylate is converted to a conductive silver structure at a temperature of about 250° C. or less. In some embodiments, the silver carboxylate is converted to a conductive silver structure at a temperature of about 100° C. or less. In some embodiments, the silver carboxylate is converted to a conductive silver structure at a temperature of about 220° C., of about 210° C. or less, of about 190° C. or less, of about 180° C. or less, of about 170° C. or less, of about 160° C. or less, of about 150° C. or less, of about 140° C. or less, of about 130° C. or less, of about 120° C. or less, of about 110° C. or less, of about 90° C. or less, of about 80° C. or less, of about 70° C. or less, of about 60° C. or less, or of about 50° C. or less.

### Silver Carboxylates

The silver carboxylates of the instant conductive ink compositions include silver salts of aliphatic carboxylic acids. In some embodiments, the silver carboxylate includes silver salts of long-chain aliphatic carboxylic acids. In specific embodiments, the silver carboxylate includes silver salts of long chain aliphatic carboxylic acids having 5 to 15 carbon atoms, 8 to 12 carbon atoms, or even 9 to 11 carbon atoms.

In preferred embodiments, the silver carboxylate of the instant compositions comprises a silver decanoate or, in particular, a silver decanoate isomer or mixture of silver decanoate isomers. For example, in some embodiments, at least one decanoic acid isomer used to generate the silver decanoate of the conductive ink composition has the following structure:

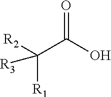

wherein R₁ and R₂ is each independently an alkyl group, wherein R₃ is either hydrogen or an alkyl group, and wherein R₁, R₂, and R₃ together comprise eight total carbon atoms. The silver decanoate formed from the above decanoic acid isomer accordingly has the following structure:

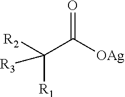

wherein the R₁, R₂, and R₃ groups have the definitions provided above. Such structures will be referred to herein as α-branched silver decanoate isomers.

In some embodiments, the R₁ and R₂ group of the α-branched silver decanoate isomer is each independently methyl or ethyl.

In specific embodiments, at least one decanoic acid isomer used to generate the silver decanoate of the instant conductive ink composition can, for example, be 2,2-dimethyloctanoic acid, 2,2,3,5-tetramethylhexanoic acid, 2,4-dimethyl-2-isopropylpentanoic acid, 2,5-dimethyl-2-ethylhexanoic acid, 2,2-diethylhexanoic acid, 2-butylhexanoic acid, or any combination of these α-branched decanoic acid isomers.

Corresponding silver carboxylates can be formed from each of these decanoic acid isomers, as described in the Examples section, and as would be understood by those of ordinary skill in the art. Specifically, the silver decanoate isomers can accordingly be, for example, an α-branched silver decanoate isomer, such as silver 2,2-dimethyloctanoate, silver 2,2,3,5-tetramethylhexanoate, silver 2,4-dimethyl-2-isopropylpentanoate, silver 2,5-dimethyl-2-ethylhexanoate, silver 2,2-diethylhexanoate, silver 2-butylhexanoate, or any combination of these compounds.

The silver carboxylate is preferably not formed from a linear alkanoic acid. For example, the silver carboxylate is preferably not formed from n-decanoic acid.

In embodiments, an amount from about 0.4 grams to about 1.0 grams of a silver carboxylate, specifically a silver decanoate comprising at least one α-branched silver decanoate isomer, is dissolved per gram of the dissolving agent. In some embodiments, about 0.4 grams, about 0.5 grams, about 0.6 grams, about 0.7 grams, about 0.8 grams, about 0.9 grams, or even about 1.0 grams of the silver carboxylate, specifically the at least one or more α-branched silver decanoate isomers, is dissolved per gram of the dissolving agent.

### Dissolving Agents

As mentioned above, the instant conductive ink compositions comprise at least one dissolving agent that is capable of dissolving the disclosed silver carboxylates, preferably fully dissolving the silver carboxylates, to generate a particle-free conductive ink composition. Specifically, the dissolving agent acts as a stabilizer and a solvent but is not intended to act as a reducing agent for the silver carboxylate. In some embodiments, the dissolving agent has a boiling point of about 250° C. or less. In some embodiments, the dissolving agent has a boiling point of about 200° C. or less. In some embodiments, the dissolving agent has a boiling point of about 100° C. or less. In some embodiments, the dissolving agent has a boiling point of about 220° C. or less, about 210° C. or less, about 190° C. or less, about 180° C. or less, about 170° C. or less, about 160° C. or less, about 150° C. or less, of about 140° C. or less, of about 130° C. or less, of about 120° C. or less, of about 110° C. or less, of about 90° C. or less, of about 80° C. or less, of about 70° C. or less, of about 60° C. or less, or of about 50° C. or less.

In some embodiments, the dissolving agent may be selected based on the type of silver carboxylate used to make the ink composition. In some embodiments, the dissolving agent may be selected based on the boiling point/tack time for a specific application. In some embodiments, the dissolving agent may be selected based on the type of substrate the ink composition will be applied to for compatibility and wettability issues. For example, for deposition methods such as inkjet printing or e-jet, greater stability is generally preferred, and thus it may be preferable to use a dissolving agent with a higher boiling point.

In some embodiments, the dissolving agent comprises an alkane hydrocarbon, a carbamate, an alkene, a cyclic hydrocarbon, an aromatic hydrocarbon, an amine, a polyamine, an amide, an ether, an ester, an alcohol, a thiol, a thioether, a phosphine, or a combination thereof.

In some embodiments, the dissolving agent comprises an organic solvent. In some embodiments, the dissolving agent comprises one or more linear or branched alkane hydrocarbons of length C₅₋₂₀. For example, the dissolving agent may comprise a pentane, a hexane, a heptane, an octane, a nonane, a decane, an undecane, a dodecane, a tridecane, a tetradecane, a pentadecane, a hexadecane, an octadecane, a nonadecane, or an icosane.

In some embodiments, the dissolving agent comprises one or more cyclic hydrocarbons of length C₆₋₁₀. For example, the dissolving agent may comprise a cyclohexane, a cycloheptane, a cyclooctane, a cyclononane, a cyclodecane, or a decalin. In some embodiments, the dissolving agent comprises an aromatic hydrocarbon. For example, the dissolving agent may comprise benzene, a toluene, a xylene, or a tetralin. In some embodiments, the dissolving agent comprises a xylene.

In some embodiments, the dissolving agent comprises a linear ether, a branched ether, or a cyclic ether. In some embodiments, the dissolving agent comprises a linear or branched ether. For example, the dissolving agent may comprise dimethyl ether, diethyl ether, dipropyl ether, dibutyl ether, or methyl t-butyl ether. In some embodiments, the dissolving agent comprises one or more cyclic ethers. For example, the dissolving agent can comprise tetrahydrofuran, tetrahydropyran, dihydropyran, or 1,4-dioxane.

In some embodiments, the dissolving agent comprises an alcohol. In some embodiments, the dissolving agent comprises a primary alcohol, a secondary alcohol, or a tertiary alcohol. In some embodiments, the alcohol comprises a propanol, a butanol, a pentanol, a hexanol, an octanol, or combinations thereof. In some embodiments, the alcohol comprises 1-propanol, 2-propanol, 1-methoxy-2-propanol, 1-butanol, 2-butanol, 1-pentanol, 2-pentanol, 3-pentanol, 1-hexanol, 2-hexanol, 3-hexanol, 1-octanol, 2-octanol, 3-octanol, tetrahydrofurfuryl alcohol, cyclopentanol, terpineol, or a combination thereof.

In some embodiments, the dissolving agent comprises a ketone. More specifically, in some embodiments, the dissolving agent comprises actylacetone.

The dissolving agent used in the instant conductive ink compositions is ideally suitable for use at an industrial scale in mass production. In some embodiments, it can therefore be advantageous for the dissolving agent to be non-toxic and/or to be less damaging to the environment than is the case for many commonly-used organic solvents. In some embodiments, it can be advantageous for the dissolving agent to have a higher flash point than is the case for many commonly-used organic solvents. In some embodiments, it can be advantageous for the dissolving agent to be subject to fewer regulations than is the case for many commonly-used organic solvents. For example, aromatic hydrocarbons such as xylene, toluene, mesitylene, and the like, are highly regulated in most industrial countries. The use alternatives to these solvents can therefore be advantageous. In addition, conductive inks formulated from aromatic hydrocarbons can have flash points that are lower than 60° C. and that are therefore not typically acceptable in mass production environments. Accordingly, in some embodiments, the dissolving agent of the instant conductive ink compositions does not comprise an aromatic hydrocarbon.

In preferred embodiments, the dissolving agent comprises a terpene, a terpenoid, or a combination thereof. For example, in some embodiments, the dissolving agent comprises a pinene, a limonene, in particular a D-limonene, a terpineol, or a combination thereof. In preferred embodiments, the dissolving agent comprises limonene. In other preferred embodiments, the dissolving agent comprises terpineol. In still other preferred embodiments, the dissolving agent comprises a combination of limonene and terpineol.

Not all terpenes and terpenoids are suitable for use in the conductive ink compositions of the instant disclosure. For example, in some embodiments, the instant dissolving agent does not comprise alpha-terpinene, gamma-terpinene, terpinolene, or terpene-4-ol. Alternatively, or in addition, in some embodiments, it can be advantageous for the dissolving agent to be a purified form of the dissolving agent. For example, in some embodiments, the dissolving agent is a purified terpineol, a purified limonene, or a combination of a purified terpineol and a purified limonene. A purified dissolving agent is understood to be at least 95% pure, at least 97% pure, at least 98% pure, at least 99% pure, or even more pure.

In some embodiments, an amount of dissolving agent is added so that the silver carboxylate is substantially dissolved or completely dissolved in the dissolving agent. In some embodiments, “substantially dissolved” means the silver carboxylate has a solubility in the dissolving agent at 25° C. of at least about 200 g/L, at least about 300 g/L, at least about 400 g/L, or even higher. In embodiments where the silver carboxylate is substantially dissolved or completely dissolved in the dissolving agent, the conductive ink composition can be considered particle-free.

In some embodiments, the conductive ink composition comprises two or more dissolving agents. In some embodiments, the volume ratio of two dissolving agents in the conductive ink is about 1 to about 1 of the first dissolving agent to the second dissolving agent. In some embodiments, the volume ratio of two dissolving agents in the conductive ink is about 2 to about 1 of the first dissolving agent to the second dissolving agent. In some embodiments, the volume ratio of two dissolving agents is about 3 to about 1 of the first dissolving agent to the second dissolving agent. In some embodiments, the volume ratio of two dissolving agents is about 4 to about 1 of the first dissolving agent to the second dissolving agent.

In some embodiments, the flash point of the conductive ink composition can be varied by varying the volume ratio of two or more dissolving agents in the conductive ink. For example, in some embodiments, the flash point of the conductive ink composition is increased by increasing the relative amount of a dissolving agent that has a higher flash point compared to a dissolving agent that has a lower flash point. More specifically, in some embodiments, the flash point of the conductive ink composition is modulated by varying the ratio of a limonene to a terpineol in the conductive ink composition. Even more specifically, the flash point of the conductive ink composition can be decreased by increasing the ratio of a limonene to a terpineol in the conductive ink composition.

### Acid Stabilizers

In another aspect are provided conductive ink compositions that comprise an organic acid to stabilize the ink composition. Although it should be understood that residual organic acids can remain present at low levels in the silver carboxylates of the instant conductive ink compositions (e.g., in the silver decanoate preparations described below), even if no additional organic acid is added to the formulation, it can in some cases be advantageous for an acid stabilizer to be added to the conductive ink formulations of the instant disclosure. For example, the presence of an acid stabilizer in the conductive ink formulations can increase the stability of the formulations, particularly during storage at elevated temperatures (e.g., at 30° C. or 40° C.). Without intending to be bound by theory, it is believed that the presence of an acid stabilizer in these formulations inhibits the formation of metallic silver during storage.

In some embodiments, the added acid stabilizer is a C₆₋₁₂ α-branched alkanoic acid. In preferred embodiments, the added acid stabilizer is one or more of the decanoic acid isomers used to generate the silver decanoate of the instant conductive ink compositions. For example, the added acid stabilizer can be an α-branched decanoic acid isomer. In other preferred embodiments, the added acid stabilizer is 2,2-dimethylhexanoic acid or 2,2-dimethylnonanoic acid.

The added acid stabilizer is preferably not a linear alkanoic acid. For example, the added acid stabilizer is preferably not n-heptanoic acid, n-octanoic acid, or n-decanoic acid. The added acid stabilizer is also preferably not a secondary alkanoic acid, such as 2-butyl hexanoic acid.

The added acid stabilizer is preferably included in a conductive ink composition in amounts ranging from 0 to 15% by weight. In some embodiments, the added acid stabilizer is included at about 0.5% by weight, about 1.5% by weight, about 5% by weight, about 10% by weight, or even about 15% by weight.

### Non-Acid Stabilizers

In another aspect are provided conductive ink compositions that comprise a non-acid stabilizer to stabilize the ink composition. The non-acid stabilizer can either be in addition to, or as an alternative to, any of the acid stabilizers described above.

In some embodiments, the non-acid stabilizer is a β-diketone.

In some embodiments, the β-diketone has the structure illustrated in formula (I):

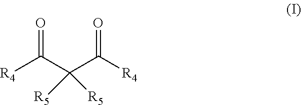

wherein each R₄ group is independently a C₁-C₆ straight-chain or branched-chain alkyl group, optionally substituted with an aryl group, or is an aryl group, and wherein each R₅ group is independently —H, a C₁-C₆ straight-chain or branched-chain alkyl group, optionally substituted with an aryl group, or wherein two R₅ groups, taken together, form a double bond that is optionally substituted with a C₁-C₆ straight-chain or branched-chain alkyl group, optionally further substituted with an aryl group, or is optionally substituted with an aryl group.

In some embodiments, the R₄ and R₅ groups of formula (I) are independently substituted with an alkoxy, hydroxy, thio, amino, halo, cyano, or nitro group.

In more specific embodiments, each R₄ group is independently a C₁-C₄ straight-chain or branched-chain alkyl group, optionally substituted with a phenyl group, or is a phenyl group, and each R₅ group is independently —H, a C₁-C₄ straight-chain or branched-chain alkyl group, optionally substituted with a phenyl group, or two R₅ groups, taken together, form a double bond that is optionally substituted with a C₁-C₄ straight-chain or branched-chain alkyl group, optionally further substituted with a phenyl group, or is optionally substituted with a phenyl group.

In even more specific embodiments, each R₄ group is independently methyl, ethyl, or phenyl, and each R₅ group is independently hydrogen, methyl, ethyl, or benzyl, or two R₅ groups, taken together, form a double bond that is optionally substituted with a methyl, ethyl, or phenyl group.

In still more specific embodiments, the β-diketone is one of the following compounds:

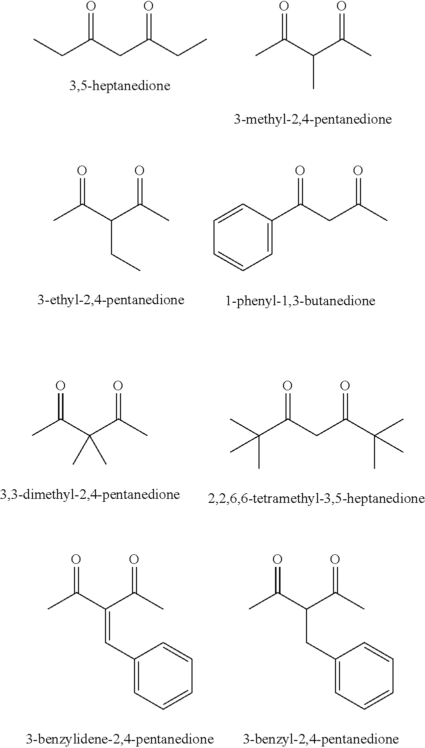

In some embodiments, the conductive ink formulations comprise more than one of any of the above-described compounds.

### Adhesion Promoters

In another aspect are provided conductive ink compositions that further comprise an adhesion promoter to increase adhesion of the ink to the substrate on which it is printed. It is envisioned that any agent that both improves the adhesive properties of the ink and that does not significantly degrade either the fluidic or other physical properties of the ink composition, including stability of the ink composition, or the electrical or other physical properties of conductive structures that are generated using the ink, can be utilized as an adhesion promoter in the instant ink compositions.

It should be understood that an adhesion promoter and an acid or β-diketone stabilizer can each be included in the conductive ink composition, either together, or separately, in any combination.

The adhesion promoter is preferably chosen in coordination with the choice of substrate on which the ink will be printed.

In some embodiments, the adhesion promoter comprises a reactive silane. Reactive silanes are known in the chemical and material science arts to enhance the performance of coatings. For example, they can improve adhesion to inorganic substrates, provide crosslinking, improve the dispersion of components of a composition, improve hydrophobicity, and scavenge moisture. In specific embodiments, the reactive silane comprises an alkoxysilane group, for example a trialkoxysilyl group. In some embodiments the alkoxysilyl group can be oligomerized or polymerized into a number of different chain length configurations. In some embodiments, the adhesion promoter comprises an alkyl group, and more specifically an alkyl group that comprises a second reactive moiety. For example, the adhesion promoter can comprise a polyalkene, for example a poly-1,2-butadiene. Suitable adhesion promoters are commercially available, for example from Gelest, Inc., Morrisville, PA, USA.

In some embodiments, the adhesion promoter comprises an epoxy group. More specifically, the adhesion promoter can comprise an epoxy group coupled to a silane, for example any of the just-described reactive silanes. In some embodiments, the adhesion promoter can comprise an epoxy group coupled to an alkoxysilane group, such as a trialkoxysilyl group. In specific embodiments, the adhesion promoter can comprise an epoxy group coupled to a trialkoxysilyl group, such as a trimethoxysilyl group or a triethoxysilyl group.

The adhesion promoter preferably comprises a linker group that couples a reactive silane group to second reactive group, for example an alkyl group comprising a reactive constituent such as a polyalkene or an epoxy group. The linker group can be any suitable chemical linker. In some embodiments, the linker group is an alkyl linker group, for example a C₂-C₁₀-alkyl linker group. In some embodiments, the linker group is a substituted alkyl linker group, where the alkyl linker group is substituted with any suitable substituent. For example, the alkyl linker group can be substituted with one or more alkyl, alkenyl, alkynyl, alkoxy, alkanoyl, alkylamino, hydroxy, thio, amino, alkanoylamino, alkylcarboxy, carbonate, halo, nitro, cyano groups, or the like. In some embodiments, one or more of the carbon atoms in the linker can be substituted with a suitable heteroatom. In specific embodiments, the heteroatom can be oxygen, sulfur, or nitrogen, in any combination. More specifically, the heteroatom can be oxygen.

In some embodiments, the adhesion promoter has the structure illustrated in formula (II):

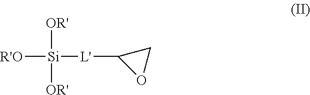

wherein each R′ is independently a C₁-C₆ alkyl group, and L′ is an alkyl linker group. In more specific embodiments of structural formula (II), each R′ is independently a methyl or an ethyl group. In other more specific embodiments of structural formula (II), L′ can be a C₂-C₁₀-alkyl linker group, including a substituted C₂-C₁₀-alkyl linker group. In some embodiments of structural formula (II), one or more of the carbon atoms in L′ can be substituted with a suitable heteroatom, for example an oxygen, a sulfur, or a nitrogen, in any combination. More specifically, the heteroatom can be oxygen.

In some more specific embodiments, the adhesion promoter has the structure illustrated in formula (III):

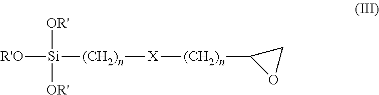

wherein each R′ is independently a methyl or an ethyl group, X is a heteroatom, and each n is independently 1-6. In some embodiments of structural formula (III), each R′ is a methyl group, X is oxygen, and each n is independently 1-3.

In some specific embodiments, the adhesion promoter of the instant conductive ink compositions is:

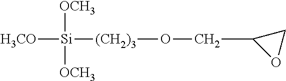

### (3-glycidyloxypropyl)trimethoxysilane

This compound is readily soluble in typical ink formulations. Specifically, ink formulations including this adhesion promoter can be prepared at 0.1-0.5% without reducing the conductivity of structures produced from the inks on different substrates. Furthermore, inks comprising this adhesion promoter are stable at 40° C. over 14-30 days with no visible precipitation or plating. These formulations likewise display viscosities suitable for use with typical industrial inkjet printhead technologies. Addition of water in the ink formulations up to 3% does not decrease stability of these inks at 40° C.

In some specific embodiments, the adhesion promoter of the instant conductive ink compositions is:

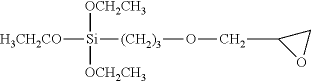

### (3-glycidyloxypropyl)triethoxysilane

### Particle-Free Conductive Ink Compositions

Provided herein are conductive ink compositions comprising the above silver carboxylates. For example, in some embodiments, the silver carboxylate is a silver decanoate, wherein the silver decanoate comprises at least one α-branched silver decanoate isomer, as described above. In some embodiments, the at least one α-branched silver decanoate isomer is the silver salt of 2,2-dimethyloctanoic acid, 2,2,3,5-tetramethylhexanoic acid, 2,4-dimethyl-2-isopropylpentanoic acid, 2,5-dimethyl-2-ethylhexanoic acid, 2,2-diethylhexanoic acid, 2-butylhexanoic acid, or any combination of these α-branched decanoic acid isomers.

In some embodiments, the instant conductive ink compositions do not contain a catalyst. In particular, when the silver carboxylate is a silver decanoate, for example a silver decanoate comprising at least one α-branched silver decanoate isomer, or a mixture of different α-branched silver decanoate isomers, it may not be necessary to include a catalyst in the composition, let alone a catalyst comprising an amine. Accordingly, in these embodiments, conductive structures can be formed from the conductive ink compositions by heating the silver complex at a temperature of about 250° C. or less to form the conductive structure.

In some embodiments, the conductive ink composition has a concentration of about 1 to about 50 weight percent silver of the conductive ink composition. In some embodiments, the conductive ink composition has a concentration of about 1 to about 40 weight percent silver of the conductive ink composition. In some embodiments, the conductive ink composition has a concentration of about 1 to about 30 weight percent silver of the conductive ink composition. In some embodiments, the conductive ink composition has a concentration of about 1 to about 20 weight percent silver of the conductive ink composition. In some embodiments, the conductive ink composition has a concentration of about 1 to about 10 weight percent silver of the conductive ink composition. In some embodiments, the conductive ink composition has a concentration of about 5 to about 15 weight percent silver of the conductive ink composition. In some embodiments, the conductive ink composition has a concentration of about 1 weight percent, about 2 weight percent, about 3 weight percent, about 4 weight percent), about 5 weight percent, about 6 weight percent, about 7 weight percent, about 8 weight percent, about 9 weight percent, about 10 weight percent), about 11 weight percent), about 12 weight percent, about 13 weight percent, about 14 weight percent, about 15 weight percent, about 16 weight percent), about 17 weight percent), about 18 weight percent, about 19 weight percent, about 20 weight percent, about 21 weight percent, about 22 weight percent), about 23 weight percent, about 24 weight percent, about 25 weight percent, about 26 weight percent, about 27 weight percent, about 28 weight percent), about 29 weight percent, about 30 weight percent, about 31 weight percent, about 32 weight percent, about 33 weight percent, about 34 weight percent), about 35 weight percent, about 36 weight percent, about 37 weight percent, about 38 weight percent, about 39 weight percent, about 40 weight percent, about 41 weight percent, about 42 weight percent, about 43 weight percent, about 44 weight percent, about 45 weight percent, about 46 weight percent, about 47 weight percent, about 48 weight percent, about 49 weight percent, about 50 weight percent, or even higher weight percent silver in the conductive ink composition.

In some embodiments, the electrical conductivity of the conductive structure formed from the conductive ink composition is measured. In some embodiments, the electrical conductivity of the conductive structure is from about 2×10⁻⁶ Ohm-cm to about 1×10⁻⁵ Ohm-cm. In some embodiments, the electrical conductivity of the conductive structure is from about 3×10⁻⁶ Ohm-cm to about 6×10⁻⁶ Ohm-cm. In some embodiments, the electrical conductivity of the conductive structure is at least about 2×10⁻⁶ Ohm-cm, about 3×10⁻⁶ Ohm-cm, about 4×10⁻⁶ Ohm-cm, about 5×10⁻⁶ Ohm-cm, about 6×10⁻⁶ Ohm-cm, about 7×10⁻⁶ Ohm-cm, about 8×10⁻⁶ Ohm-cm, or about 9×10⁻⁶ Ohm-cm. In some embodiments, the electrical conductivity of the conductive structure is at most about 1×10⁻⁵ Ohm-cm, about 9×10⁻⁶ Ohm-cm, about 8×10⁻⁶ Ohm-cm, about 7×10⁻⁶ Ohm-cm, about 6×10⁻⁶ Ohm-cm, about 5×10⁻⁶ Ohm-cm, about 4×10⁻⁶ Ohm-cm, or about 3×10⁻⁶ Ohm-cm.

The electrical conductivity of the conductive structure may in some embodiments be expressed in terms of sheet resistance (i.e., bulk resistivity divided by thickness) in units of ohms per square (also referred to as ohms/square or OPS). For example, in some embodiments, the resistance of the conductive structure is no more than 5 ohms per square, no more than 2 ohms per square, no more than 1 ohm per square, no more than 0.5 ohms per square, or even lower. Preferably, the resistance of the conductive structure is no more than 1 ohm per square.

The conductive ink compositions of the instant disclosure can be used to form conductive structures having high levels of bulk silver. Specifically, in some embodiments, the conductive structure has a bulk silver content of at least 1%. In more specific embodiments, the conductive structure has a bulk silver content of at least 2%, at least 5%, at least 10%, at least 15%, at least 20%, or even higher.

### Methods for Making Conductive Ink Compositions

According to another aspect, the disclosure provides methods of making a conductive ink composition, in particular any of the conductive ink compositions described above. These methods comprise the step of dissolving a silver decanoate in at least one dissolving agent to form a conductive ink composition, wherein the silver decanoate comprises at least one α-branched silver decanoate isomer, for example, any of the silver decanoates described above, and the at least one dissolving agent comprises a terpene, a terpenoid; or a combination thereof. The conductive ink compositions formed by these methods preferably further comprise at least one non-acid stabilizer, in particular any of the non-acid stabilizers described above.

### Methods for Forming a Conductive Structure

In another aspect are disclosed methods of making conductive structures. In some embodiments, the methods include the step of applying any of the conductive ink composition described above to a suitable substrate. In some embodiments, the methods include the step of heating the conductive ink composition on the substrate at a decomposition temperature of about 250° C. or less to form the conductive structure. In some embodiments, the methods include the step of heating the conductive ink composition on the substrate at a decomposition temperature of about 100° C. or less to form the conductive structure. In some embodiments, the methods include the step of heating the conductive ink composition on the substrate at a decomposition temperature of about 210° C. or less, of about 200° C. or less, of about 190° C., of about 180° C. or less, of about 170° C. or less, of about 160° C., of about 150° C. or less, of about 140° C. or less, of about 130° C. or less, of about 120° C. or less, of about 110° C. or less, of about 90° C. or less, of about 80° C. or less, of about 70° C. or less, of about 60° C. or less, or of about 50° C. or less to form the conductive structure. In some embodiments, the conductive ink composition is heated with a heat source. Examples of heat sources include an IR lamp, oven, or a heated substrate.

In preferred embodiments, the conductive ink compositions of the instant methods do not comprise a catalyst. More specifically, in some embodiments, the conductive ink compositions of the instant methods do not comprise a catalyst comprising an amine.

In some embodiments, the conductive ink composition of the instant methods has a desired viscosity. In some embodiments, the desired viscosity is obtained using a micro VISC viscometer. In some embodiments, the conductive ink composition has a viscosity from about 50 centipoise to about 1000 centipoise. In some embodiments, the conductive ink composition has a viscosity from about 5 centipoise to about 50 centipoise. In some embodiments, the conductive ink composition has a viscosity from about 10 centipoise to about 40 centipoise. In some embodiments, the conductive ink composition has a viscosity from about 20 centipoise to about 30 centipoise. In some embodiments, the conductive ink composition has a viscosity from about 18 centipoise to about 20 centipoise. In some embodiments, the conductive ink composition has a viscosity of about 18, about 19, or about 20 centipoise. In some embodiments, the conductive ink composition has a viscosity of at least about 5 centipoise, about 10 centipoise, about 20 centipoise, about 30 centipoise, about 40 centipoise, about 50 centipoise, about 60 centipoise, about 70 centipoise, about 80 centipoise, about 90 centipoise, about 100 centipoise, about 200 centipoise, about 300 centipoise, about 400 centipoise, about 500 centipoise, about 600 centipoise, about 700 centipoise, about 800 centipoise, or about 900 centipoise. In some embodiments, the conductive ink composition has a viscosity of at most about 1000 centipoise, about 900 centipoise, about 800 centipoise, about 700 centipoise, about 600 centipoise, about 500 centipoise, about 400 centipoise, about 300 centipoise, about 200 centipoise, about 10⁰ centipoise, about 90 centipoise, about 80 centipoise, about 70 centipoise, about 60 centipoise, about 50 centipoise, about 40 centipoise, about 30 centipoise, about 20 centipoise, or about 10 centipoise.

In some embodiments, the viscosity of the conductive ink composition is adjusted based upon the amount of dissolving agent used. In some embodiments, the viscosity of the complex is adjusted based upon the type of dissolving agent used. For example, in embodiments where the dissolving agent comprises limonene and terpineol, an increase in the percentage of terpineol in the conductive ink composition can increase the viscosity of the ink. In some embodiments, the viscosity of silver complex can be tuned from less than 5 centipoise with a large proportion of limonene to 50 centipoise with a large portion of terpineol. Unless otherwise indicated, all viscosity values are for samples at room temperature.

### Applications of the Conductive Ink Compositions

The conductive ink compositions of the instant disclosure can be used in various printing applications, including slot die coating, spin coating, roll-to-roll printing, including gravure, flexography, rotary screen printing, screen printing, aerosol jet printing, inkjet printing, airbrushing, Mayer rod coating, flood coating, 3D printing, dispenser, and electrohydrodynamic printing. In particular, the inks can be used in inkjet printing, dip coating, and spray coating.

Furthermore, patterns can be created using photolithography to create a mask to etch silver from certain areas, thereby creating high-fidelity features. Both positive and negative patterning processes may be used to create the patterns.

In some embodiments, the silver salt of the silver carboxylate is completely dissolved in at least one dissolving agent. The fully dissolved silver salt is compatible with many nonpolar polymer substrates, glasses, and ceramic substrates where polar complexes do not wet particularly well. In some embodiments, the conductive ink composition comprising the silver complex is applied to a polymer substrate, for example a flexible polymer substrate, such as a polyimide (PI) substrate, for example Kapton. In some embodiments, the conductive ink composition comprising the silver complex is applied to a nonpolar polymer substrate. In some embodiments, the conductive ink composition comprising the silver complex is applied to a glass substrate. In some embodiments, the conductive ink composition comprising the silver complex is applied to a ceramic substrate.

Furthermore, elastomers and 3D substrates with specifically non-planar topography can be used in conjunction with the conductive structures. In some embodiments, the conductive ink composition comprising the silver complex is applied to an elastomer. In some embodiments, the conductive ink composition comprising the silver complex is applied to a 3D substrate.

In some embodiments, the conductive ink compositions of the instant disclosure can be applied to an epoxy substrate, such as, for example, an epoxy molding compound (EMC) substrate or the like.

In some embodiments, the conductive ink compositions of the instant disclosure can be applied to a silver nanowire (SNW) substrate, a solder resist substrate (also referred to as a solder mask substrate), or any other suitable substrate material.

In some embodiments, the ink composition of the instant methods has a concentration of about 0.1-50 weight percent metal salt of the ink composition. In some embodiments, the ink composition of the instant methods has a concentration of about 0.1-40 weight percent metal salt of the ink composition. In some embodiments, the ink composition has a concentration of about 1-30 weight percent metal salt of the ink composition. In some embodiments, the ink composition has a concentration of about 1-20 weight percent metal salt of the ink composition. In some embodiments, the ink composition has a concentration of about 1-10 weight percent metal salt of the ink composition. In some embodiments, the ink composition has a concentration of about 5-15 weight percent metal salt of the ink composition. In some embodiments, the ink composition has a concentration of about 0.1 weight percent), about 0.2 weight percent), about 0.3 weight percent>, about 0.4 weight percent>, about 0.5 weight percent>, about 0.6 weight percent>, about 0.7 weight percent, about 0.8 weight percent, about 0.9 weight percent, about 1 weight percent, about 2 weight percent, about 3 weight percent, about 4 weight percent), about 5 weight percent), about 6 weight percent, about 7 weight percent, about 8 weight percent, about 9 weight percent, about 10 weight percent, about 11 weight percent), about 12 weight percent, about 13 weight percent, about 14 weight percent, about 15 weight percent, about 16 weight percent, about 17 weight percent), about 18 weight percent, about 19 weight percent, or about 20 weight percent metal of the ink composition.

In some embodiments, the ink composition of the instant methods has a concentration of at least about 0.1 weight percent, about 0.2 weight percent, about 0.3 weight percent, about 0.4 weight percent, about 0.5 weight percent, about 0.6 weight percent, about 0.7 weight percent, about 0.8 weight percent, about 0.9 weight percent, 1 weight percent, about 2 weight percent, about 3 weight percent, about 4 weight percent), about 5 weight percent), about 6 weight percent, about 7 weight percent, about 8 weight percent, about 9 weight percent, about 10 weight percent, about 11 weight percent), about 12 weight percent, about 13 weight percent, about 14 weight percent, about 15 weight percent, about 16 weight percent, about 17 weight percent), about 18 weight percent, about 19 weight percent, or about 20 weight percent metal salt of the ink composition. In some embodiments, the ink composition has a concentration of at most about 40 weight percent), about 39 weight percent, about 38 weight percent, about 37 weight percent, about 36 weight percent, about 35 weight percent, about 34 weight percent, about 33 weight percent, about 32 weight percent, 31 weight percent, about 30 weight percent, about 29 weight percent, about 28 weight percent, about 27 weight percent), about 26 weight percent, about 25 weight percent, about 24 weight percent, about 23 weight percent, about 22 weight percent, about 21 weight percent), about 20 weight percent, about 19 weight percent, about 18 weight percent, about 17 weight percent, about 16 weight percent, about 15 weight percent, about 14 weight percent, about 13 weight percent, or about 12 weight percent metal salt of the ink composition.

In some embodiments, the ink composition of the instant methods has a concentration of about 0.1-50 weight percent metal complex of the ink composition. In some embodiments, the ink composition of the instant methods has a concentration of about 0.1-40 weight percent metal complex of the ink composition. In some embodiments, the ink composition has a concentration of about 1-30 weight percent metal complex of the ink composition. In some embodiments, the ink composition has a concentration of about 1-20 weight percent metal complex of the ink composition. In some embodiments, the ink composition has a concentration of about 1-10 weight percent metal complex of the ink composition. In some embodiments, the ink composition has a concentration of about 5-15 weight percent metal complex of the ink composition. In some embodiments, the ink composition has a concentration of about 0.1 weight percent, about 0.2 weight percent, about 0.3 weight percent, about 0.4 weight percent, about 0.5 weight percent, about 0.6 weight percent, about 0.7 weight percent, about 0.8 weight percent, about 0.9 weight percent), 1 weight percent), about 2 weight percent, about 3 weight percent, about 4 weight percent, about 5 weight percent, about 6 weight percent, about 7 weight percent), about 8 weight percent), about 9 weight percent, about 10 weight percent, about 11 weight percent, about 12 weight percent, about 13 weight percent), about 14 weight percent), about 15 weight percent, about 16 weight percent, about 17 weight percent, about 18 weight percent, about 19 weight percent, or about 20 weight percent metal complex of the ink composition.

### Decomposition

In another aspect, the conductive ink compositions of the disclosure are decomposed on a substrate to form a conductive structure on the substrate. In some embodiments, the conductive ink composition is decomposed by heating the reducible metal complex at a temperature of about 270° C. or less. In some embodiments, the conductive ink composition is decomposed by heating the conductive ink composition at a temperature of about 260° C. or less, about 250° C. or less, about 240° C. or less, about 230° C. or less, about 220° C. or less, about 210° C. or less, about 200° C. or less, about 190° C. or less, about 180° C. or less, about 170° C. or less, about 160° C. or less, about 150° C. or less, about 140° C. or less, about 130° C. or less, about 120° C. or less, about 110° C. or less, about 100° C. or less, about 90° C. or less, about 80° C. or less, or about 70° C. or less. In some embodiments, the conductive ink composition is heated by a heat source. Examples of heat sources include an IR lamp, oven, or a heated substrate.

In some embodiments, the conductive ink composition is decomposed by exposing the composition to a light source at a wavelength from about 100 nm to about 1500 nm. In some embodiments, the conductive ink composition is decomposed by exposing the composition to a light source such as a Xenon lamp or IR lamp at a wavelength from about 100 nm to about 1000 nm. In some embodiments, the conductive ink composition is decomposed by exposing the composition to a light source at a wavelength from about 100 nm to about 700 nm. In some embodiments, the conductive ink composition is decomposed by exposing the composition to a light source at a wavelength from about 100 nm to about 500 nm. In some embodiments, the conductive ink composition is decomposed by exposing the composition to a light source at a wavelength from about 100 nm to about 300 nm. In some embodiments, the conductive ink composition is decomposed by exposing the composition to a light source at a wavelength of about 100 nm, about 200 nm, about 300 nm, about 400 nm, about 500 nm, about 600 nm, about 700 nm, about 800 nm, about 900 nm, or about 1000 nm.

In some embodiments, the conductive ink composition is decomposed by a combination of heating the reducible metal complex, for example at any of the above-listed temperatures, and exposing the composition to a light source, for example at any of the above-listed wavelengths.

In some embodiments, the electrical conductivity of the conductive structures is measured. In some embodiments, the electrical conductivity of the conductive structures is about 1×10⁻⁶ Ohm-cm or greater. In some embodiments, the electrical conductivity of the conductive structures is from about 1×10⁻⁶ Ohm-cm to about 8×10⁻⁴ Ohm-cm. In some embodiments, the electrical conductivity of the conductive structures is from about 3×10⁻⁶ Ohm-cm to about 6×10⁻⁶ Ohm-cm. In some embodiments, the electrical conductivity of the conductive structures is at least about 1×10⁻⁶ Ohm-cm, about 2×10⁻⁶ Ohm-cm, about 3×10⁻⁶ Ohm-cm, about 4×10⁻⁶ Ohm-cm, about 5×10⁻⁶ Ohm-cm, about 6×10⁻⁶ Ohm-cm, about 7×10⁻⁶ Ohm-cm, about 8×10⁻⁶ Ohm-cm, about 9×10⁻⁶ Ohm-cm, about 1×10⁻⁵ Ohm-cm, about 2×10⁻⁵ Ohm-cm, about 3×10⁻⁵ Ohm-cm, about 4×10⁻⁵ Ohm-cm, about 5×10⁻-5 Ohm-cm, about 6×10⁻⁵ Ohm-cm, about 7×10⁻⁵ Ohm-cm, about 8×10⁻⁵ Ohm-cm, about 9×10⁻⁵ Ohm-cm, about 1×10⁻⁴ Ohm-cm, about 2×10⁻⁴ Ohm-cm, about 3×10⁻⁴ Ohm-cm, about 4×10⁻⁴ Ohm-cm, about 5×10⁻⁴ Ohm-cm, about 6×10⁻⁴ Ohm-cm, or about 7×10⁻-4 Ohm-cm. In some embodiments, the electrical conductivity of the conductive structures is at most about 8×10⁻⁴ Ohm-cm, 7×10⁻⁴ Ohm-cm, about 6×10⁻⁴ Ohm-cm, about 5×10⁻⁴ Ohm-cm, about 4×10⁻⁴ Ohm-cm, about 3×10⁻⁴ Ohm-cm, about 2×10⁻⁴ Ohm-cm, or about 1×10⁻-4 Ohm-cm, about 9×10⁻⁵ Ohm-cm, about 8×10⁻⁵ Ohm-cm, about 7×10⁻⁵ Ohm-cm, about 6×10⁻⁵ Ohm-cm, about 5×10⁻⁵ Ohm-cm, about 4×10⁻⁵ Ohm-cm, about 3×10⁻⁵ Ohm-cm, about 2×10⁻⁵ Ohm-cm, about 1×10⁻⁵ Ohm-cm, about 9×10⁻⁶ Ohm-cm, about 8×10⁻⁶ Ohm-cm, about 7×10⁻⁶ Ohm-cm, about 6×10⁻⁶ Ohm-cm, about 5×10⁻⁶ Ohm-cm, about 4×10⁻⁶ Ohm-cm, about 3×10⁻⁶ Ohm-cm, or about 2×10⁻⁶ Ohm-cm.

It will be readily apparent to one of ordinary skill in the relevant arts that other suitable modifications and adaptations to the compositions and methods described herein may be made without departing from the scope of the invention or any embodiment thereof. Having now described the present invention in detail, the same will be more clearly understood by reference to the following Examples, which are included herewith for purposes of illustration only and are not intended to be limiting of the invention.

### EXAMPLES

### Preparation of Silver Decanoate

The decanoic acid used to form the silver carboxylates of the instant improved conductive ink compositions preferably comprises at least one α-branched silver decanoic acid isomer. The decanoic acid can be converted to a silver decanoate for use in the conductive ink compositions according to the following general protocol:

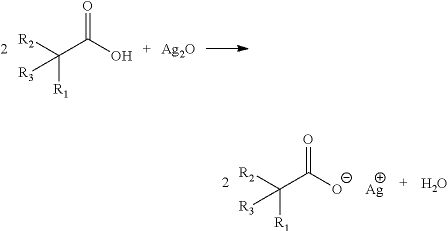

In the above structures, R₁ and R₂ is each independently an alkyl group, wherein R₃ is either hydrogen or an alkyl group, and wherein R₁, R₂, and R₃ together comprise eight total carbon atoms.

In one exemplary preparation of a silver decanoate isomer mixture, Ag₂O powder (13.58 g, 0.058 mol) was slowly added to a solution of a mixture of decanoic acid isomers (21.20 g, 0.12 mol) in dry THF (175 mL) and stirred at room temperature. After 3 hours, the black silver oxide dissolved to form a grey-white solution. The mixture continued to stir overnight until it became a creamy white solution. On completion, methanol (600 mL) was poured into the mixture to precipitate silver decanoate. The solvent was removed and more methanol (600 mL) was added to remove excess decanoic acids. Finally, excess methanol was removed and silver decanoate was collected by centrifugation (20 g, 60%) as a white solid.

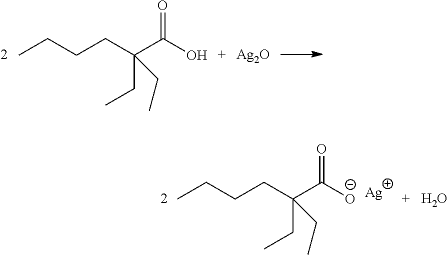

In another exemplary preparation of a silver decanoate, Ag₂O powder (3.01 g, 0.013 mol) was slowly added to a solution of 2,2-diethylhexanoic acid (5.000 g, 0.029 mol) in dry THF (45 mL) and stirred at room temperature. After 24 hrs, the black silver oxide dissolved to form a grey-white solution. The mixture was stirred for another 24 hrs until it became a creamy white solution. On completion, methanol (200 mL) was poured into the mixture to precipitate silver-2,2-diethyl hexanoate (Ag-2,2-DEHA). The solvent was removed and more methanol (200 mL) was added to remove excess 2,2-diethylhexanoic acid. Finally, excess methanol was removed and Ag-2,2-DEHA was collected by centrifugation (1.74 g, 21%) as a white solid.

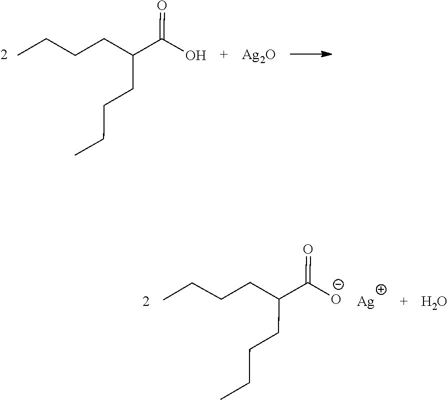

In yet another exemplary preparation of a silver decanoate, Ag₂O powder (3.01 g, 0.013 mol) was slowly added to a solution of 2-butylhexanoic acid (5.000 g, 0.029 mol) in dry THF (45 mL) and stirred at room temperature. After 48 hrs, the black silver oxide dissolved to form a grey-white solution. The mixture was stirred for another 24 hrs until it became a creamy white solution. On completion, methanol (200 mL) was poured into the mixture to precipitate silver-2-butylhexanoate (Ag-2-BHA). The solvent was removed and more methanol (200 mL) was added to remove excess 2-butylhexanoic acid. Finally, excess methanol was removed and Ag-2-BHA was collected by centrifugation (3.4 g, 42%) as a white solid.

Exemplary Ink Formulations Comprising Silver Decanoate and their Curing Profiles

Conductive ink compositions are prepared generally as described in U.S. Patent Application No. 63/316,949, filed on Mar. 4, 2022, U.S. Patent Application No. 63/370,343, filed on Aug. 3, 2022, and U.S. Patent Application No. 63/384,202, filed on Nov. 17, 2022.

### Formulation 1

A control ink formulation contained 45% silver decanoate isomer mixture in 55% limonene with post-addition of 3% decanoic acid isomer mixture as an acid stabilizer. In the following formulations, the post-addition decanoic acid isomer stabilizer is substituted with the listed test stabilizer compound.

### Formulation 2

45% silver decanoate isomer mixture in 55% limonene with post-addition of 3% 3,5-heptanedione.

### Formulation 3

45% silver decanoate isomer mixture in 55% limonene with post-addition of 3% 3-methyl-2,4-pentanedione.

### Formulation 4

45% silver decanoate isomer mixture in 55% limonene with post-addition of 3% 3-ethyl-2,4-pentanedione.

### Formulation 5

45% silver decanoate isomer mixture in 55% limonene with post-addition of 3% 1-phenyl-1,3-butanedione.

### Formulation 6

45% silver decanoate isomer mixture in 55% limonene with post-addition of 3% 3,3-dimethyl-2,4-pentanedione.

### Formulation 7

45% silver decanoate isomer mixture in 55% limonene with post-addition of 3% 2,2,6,6-tetramethyl-3,5-heptanedione.

### Formulation 8

45% silver decanoate isomer mixture in 55% limonene with post-addition of 3% 3-benzylidene-2,4-pentanedione.

### Formulation 9

45% silver decanoate isomer mixture in 55% limonene with post-addition of 3% 3-benzyl-2,4-pentanedione.

### Formulation 10

45% silver decanoate isomer mixture in 55% limonene with post-addition of 0.5% 3-glycidyloxypropyl) trimethoxysilane (GLYMO) and 3% 3,3-dimethyl-2,4-pentanedione.

### Formulation 11

45% silver decanoate isomer mixture in 55% limonene with post-addition of 0.5% 3-glycidyloxypropyl) trimethoxysilane (GLYMO) and 3% 2,2,6,6-tetramethyl-3,5-heptanedione.

### Formulation 12

45% silver decanoate isomer mixture in 55% limonene with post-addition of 0.5% decanoic acid isomer mixture.

### Formulation 13

45% silver decanoate isomer mixture in 55% limonene with post-addition of 1% 3,3-dimethyl-2,4-pentanedione.

### Formulation 14

45% silver decanoate isomer mixture in 55% limonene with post-addition of 1% 2,2,6,6-tetramethyl-3,5-heptanedione.

### Formulation 15

45% silver decanoate isomer mixture in 55% limonene with post-addition of 0.5% decanoic acid isomer mixture and 0.5% 3,3-dimethyl-2,4-pentanedione.

### Formulation 16

45% silver decanoate isomer mixture in 55% limonene with post-addition of 0.5% decanoic acid isomer mixture and 0.5% 2,2,6,6-tetramethyl-3,5-heptanedione.

Characterization of Conductive Ink Formulations with β-Diketone Stabilizers

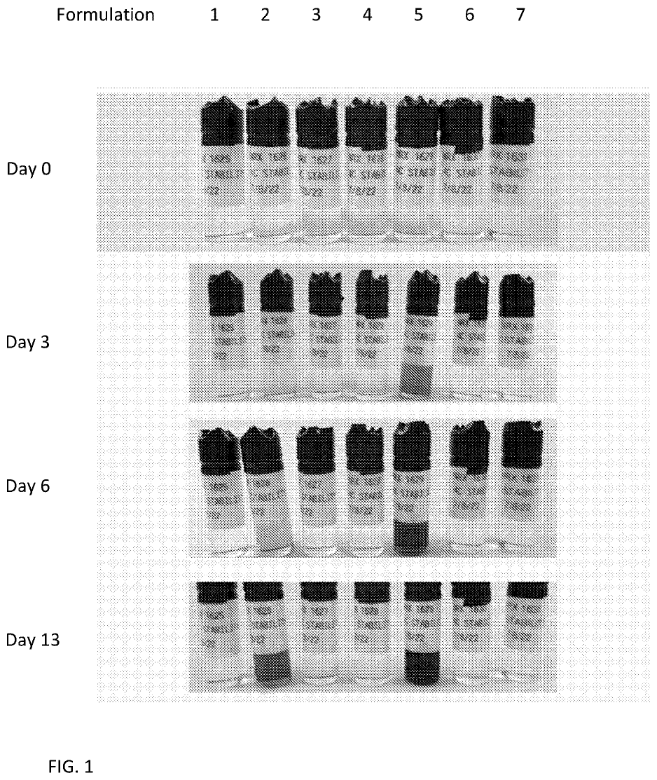

FIG. 1 illustrates the stability of Formulations 1-7 at low temperature. Each formulation was sealed in a glass vial and held at 4° C. for the indicated times. As indicated in the above descriptions of these formulations, each sample included 45% of the silver decanoate isomer mixture, 55% limonene, and 3% of the test stabilizer. The Formulation 1 control included a 3% post-addition of the decanoic acid isomer mixture instead of the test stabilizer.

Test solutions remaining clear during the time course of the test (i.e., Formulation 6 and Formulation 7 at day 13) are considered to be stable under the test conditions.

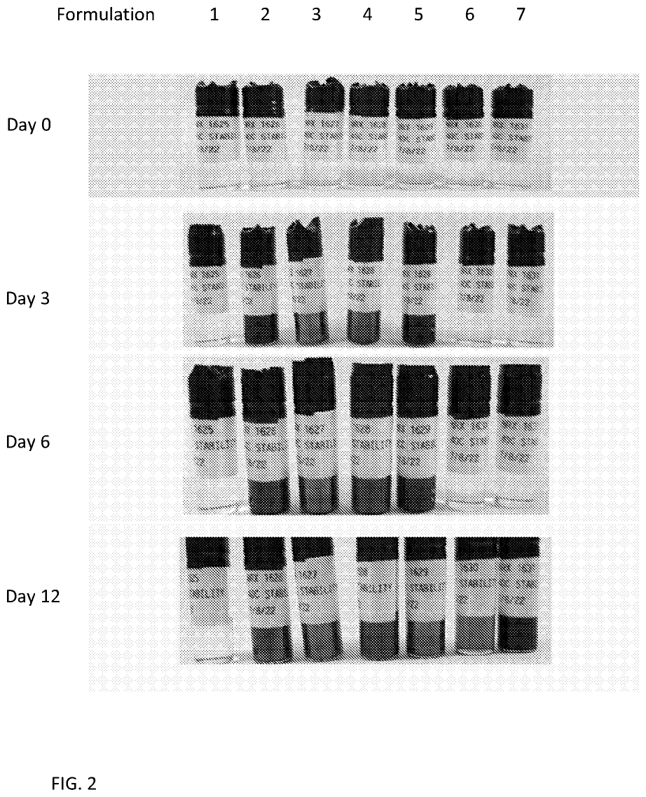

FIG. 2 illustrates the stability of Formulations 1-7 at elevated temperature. Each formulation was sealed in a glass vial and held at 40° C. for the indicated times. Only the control solution (Formulation 1) remained clear during the time course of the test and was considered to be stable under the test conditions.

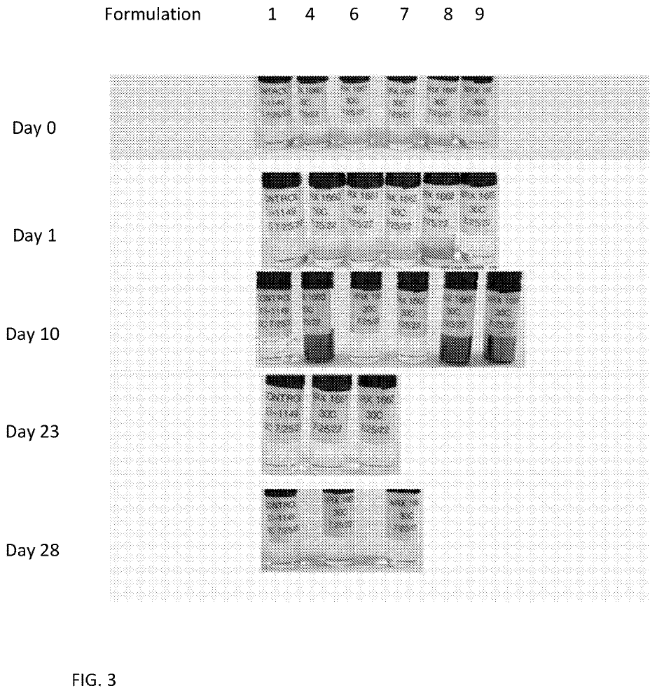

FIG. 3 illustrates the stability of Formulations 1, 4, 6, 7, 8, and 9 at elevated temperature. As shown in this experiment, Formulations 1, 6, and 7 (the only vials shown at days 23 and 28) remained clear at 30° C. for at least 28 days under the test conditions.

Table 1 summarizes the resistivity of conductive structures formed from stable inks that have been formulated either with or without an adhesion promoter. All of the inks were bar-coated on microscopic glass using a suitable bar and cured at 180° C. for 1 hr.

TABLE 1
Resistivity of conductive structures formed from ink
compositions that are stable at room temperature.

| | OPS |
|---|---|
| Ink | (mohm/Sq) |
| Formulation 1 | ~50 |
| (control) | |
| Formulation 10 | 53.8 |
| Formulation 6 | 58.9 |
| Formulation 11 | 59.4 |
| Formulation 7 | 45.32 |

The results shown in Table 1 indicate that the added components are easily removed from the conductive structure upon curing without affecting the resistivity. In addition, all of the inks tested in Table 1 print well under standard conditions.

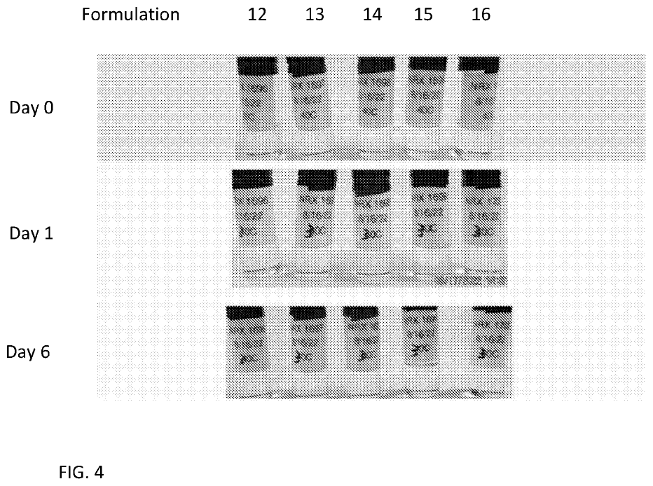

FIG. 4 illustrates the effect of stabilizer concentration on the stability of ink formulations at 30° C. These results show that the concentration of the stabilizer can be decreased without significantly decreasing the stability of the ink at this temperature at these times.

All patents, patent publications, and other published references mentioned herein are hereby incorporated by reference in their entireties as if each had been individually and specifically incorporated by reference herein.

While specific examples have been provided, the above description is illustrative and not restrictive. Any one or more of the features of the previously described embodiments can be combined in any manner with one or more features of any other embodiments in the present invention. Furthermore, many variations of the invention will become apparent to those skilled in the art upon review of the specification. The scope of the invention should, therefore, be determined by reference to the appended claims, along with their full scope of equivalents.

1. A conductive ink composition comprising:
a silver decanoate;
at least one dissolving agent; and
at least one non-acid stabilizer;
wherein the at least one dissolving agent comprises a terpene, a terpenoid, or a combination thereof; and
wherein the silver decanoate is decarboxylated at a temperature of 250° C. or less to form a conductive structure.

2. The conductive ink composition of claim 1, wherein the at least one non-acid stabilizer is a β-diketone.

3. The conductive ink composition of claim 2,
wherein the β-diketone has a structure of formula (I): 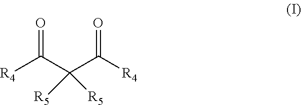
wherein each R₄ group is independently a C₁-C₆ straight-chain or branched-chain alkyl group, optionally substituted with an aryl group, or is an aryl group, and
wherein each R₅ group is independently —H, a C₁-C₆ straight-chain or branched-chain alkyl group, optionally substituted with an aryl group, or wherein two R₅ groups, taken together, form a double bond that is optionally substituted with a C₁-C₆ straight-chain or branched-chain alkyl group, optionally further substituted with an aryl group, or is optionally substituted with an aryl group.

4. The conductive ink composition of claim 3,
wherein each R₄ and R₅ group is independently substituted with an alkoxy, hydroxy, thio, amino, halo, cyano, or nitro group.

5. The conductive ink composition of claim 3,
wherein each R₄ group is independently a C₁-C₄ straight-chain or branched-chain alkyl group, optionally substituted with a phenyl group, or is a phenyl group, and
wherein each R₅ group is independently —H, a C₁-C₄ straight-chain or branched-chain alkyl group, optionally substituted with a phenyl group, or wherein two R₅ groups, taken together, form a double bond that is optionally substituted with a C₁-C₄ straight-chain or branched-chain alkyl group, optionally further substituted with a phenyl group, or is optionally substituted with a phenyl group.

6. The conductive ink composition of claim 5,
wherein each R₄ group is independently methyl, ethyl, or phenyl, and
wherein each R₅ group is independently hydrogen, methyl, ethyl, or benzyl, or wherein two R₅ groups, taken together, form a double bond that is optionally substituted with a methyl, ethyl, or phenyl group.

7. The conductive ink composition of claim 1, wherein the silver decanoate comprises at least one α-branched silver decanoate isomer.

8. The conductive ink composition of claim 1, wherein the silver decanoate comprises a plurality of α-branched silver decanoate isomers.

9. The conductive ink composition of claim 1, wherein the silver decanoate has a structure: 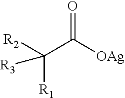
wherein R₁ and R₂ is each independently an alkyl group, wherein R₃ is either hydrogen or an alkyl group, and wherein R₁, R₂, and R₃ together comprise eight total carbon atoms.

10. The conductive ink composition of claim 9, wherein R₁ and R₂ is each independently methyl or ethyl.

11. The conductive ink composition of claim 9, wherein the silver decanoate comprises silver 2,2-dimethyloctanoate, silver 2,2,3,5-tetramethylhexanoate, silver 2,4-dimethyl-2-isopropylpentanoate, silver 2,5-dimethyl-2-ethylhexanoate, silver 2,2-diethylhexanoate, silver 2-butylhexanoate, or a combination thereof.

12. The conductive ink composition of claim 1, wherein the conductive ink composition is particle free.

13. The conductive ink composition of claim 1, wherein the terpene is a purified terpene or the terpenoid is a purified terpenoid.

14. The conductive ink composition of claim 1, wherein the terpene is a pinene or a limonene.

15. The conductive ink composition of claim 1, wherein the terpenoid is a terpineol.

16. The conductive ink composition of claim 1, wherein the at least one dissolving agent comprises a limonene.

17. The conductive ink composition of claim 16, wherein the limonene is a purified limonene.

18. The conductive ink composition of claim 1, further comprising an adhesion promoter.

19. The conductive ink composition of claim 18, wherein the adhesion promoter comprises a reactive silane.

20. The conductive ink composition of claim 19, wherein the adhesion promoter comprises an alkoxysilane.

21. The conductive ink composition of claim 20, wherein the adhesion promoter comprises an ethoxysilyl modified polyalkene.

22. The conductive ink composition of claim 21, wherein the adhesion promoter comprises a triethoxysilyl modified poly-1,2-butadiene.

23-33. (canceled)

34. The conductive ink composition of claim 1, further comprising an acid stabilizer.

35. The conductive ink composition of claim 34, wherein the acid stabilizer is a C₆₋₁₂ α-branched alkanoic acid.

36. The conductive ink composition of claim 35, wherein the acid stabilizer is an α-branched decanoic acid isomer.

37. The conductive ink composition of claim 36, wherein the acid stabilizer is 2,2-dimethylhexanoic acid or 2,2-dimethylnonanoic acid.

38. The conductive ink composition of claim 1, wherein the silver decanoate comprises at least one α-branched silver decanoate isomer, the at least one dissolving agent is a limonene, the at least one non-acid stabilizer is a β-diketone, and the conductive ink composition further comprises an adhesion promoter comprising a reactive silane.

39. The conductive ink composition of claim 38, further comprising an acid stabilizer.

40. The conductive ink composition of claim 1, wherein the silver decanoate comprises at least one α-branched silver decanoate isomer, the at least one dissolving agent is a limonene, the at least one non-acid stabilizer is a β-diketone, and the conductive ink composition further comprises an acid stabilizer.

41. The conductive ink composition of claim 1, wherein the conductive ink composition has a concentration of about 1 to about 50 weight percent silver decanoate.

42. The conductive ink composition of claim 1, wherein the conductive ink composition has a viscosity from about 5 centipoise to about 50 centipoise.

43. The conductive ink composition of claim 1, wherein the conductive ink composition has a viscosity from about 50 centipoise to about 1000 centipoise.

44. The conductive ink composition of claim 1, wherein the conductive structure has a resistance of no more than 5 ohms per square, no more than 2 ohms per square, no more than 1 ohm per square, or no more than 0.5 ohms per square.

45. The conductive ink composition of claim 1, wherein the conductive structure has a bulk silver content of at least 1%.

46. The conductive ink composition of claim 1, wherein the silver decanoate is decarboxylated at a temperature of 180° C. or less to form a conductive structure.

47. The conductive ink composition of claim 1, wherein the silver decanoate is decarboxylated at a temperature of 150° C. or less to form a conductive structure.

48. A method of making a conductive ink composition, comprising:
dissolving a silver decanoate in at least one dissolving agent to form a conductive ink composition;
wherein the silver decanoate comprises at least one α-branched silver decanoate isomer and the at least one dissolving agent comprises a terpene, a terpenoid; or a combination thereof; and
wherein the conductive ink composition further comprises at least one non-acid stabilizer.

49. The method of claim 48, wherein the at least one non-acid stabilizer is a β-diketone.

50. The method of claim 49,
wherein the β-diketone has a structure of formula (I): 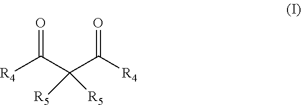
wherein each R₄ group is independently a C₁-C₆ straight-chain or branched-chain alkyl group, optionally substituted with an aryl group, or is an aryl group, and
wherein each R₅ group is independently —H, a C₁-C₆ straight-chain or branched-chain alkyl group, optionally substituted with an aryl group, or wherein two R₅ groups, taken together, form a double bond that is optionally substituted with a C₁-C₆ straight-chain or branched-chain alkyl group, optionally further substituted with an aryl group, or is optionally substituted with an aryl group.

51. The method of claim 50,
wherein each R₄ and R₅ group is independently substituted with an alkoxy, hydroxy, thio, amino, halo, cyano, or nitro group.

52. The method of claim 50,
wherein each R₄ group is independently a C₁-C₄ straight-chain or branched-chain alkyl group, optionally substituted with a phenyl group, or is a phenyl group, and
wherein each R₅ group is independently —H, a C₁-C₄ straight-chain or branched-chain alkyl group, optionally substituted with a phenyl group, or wherein two R₅ groups, taken together, form a double bond that is optionally substituted with a C₁-C₄ straight-chain or branched-chain alkyl group, optionally further substituted with a phenyl group, or is optionally substituted with a phenyl group.

53. The method of claim 52,
wherein each R₄ group is independently methyl, ethyl, or phenyl, and
wherein each R₅ group is independently hydrogen, methyl, ethyl, or benzyl, or wherein two R₅ groups, taken together, form a double bond that is optionally substituted with a methyl, ethyl, or phenyl group.

54. The method of claim 48, wherein the conductive ink composition is particle-free.

55. The method of claim 48, wherein the silver decanoate comprises a plurality of α-branched silver decanoate isomers.

56. The method of claim 48, wherein the silver decanoate has a structure: 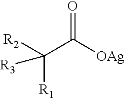
wherein R₁ and R₂ is each independently an alkyl group, wherein R₃ is either hydrogen or an alkyl group, and wherein R₁, R₂, and R₃ together comprise eight total carbon atoms.

57. The method of claim 56, wherein R₁ and R₂ is each independently methyl or ethyl.

58. The method of claim 56, wherein the silver decanoate comprises silver 2,2-dimethyloctanoate, silver 2,2,3,5-tetramethylhexanoate, silver 2,4-dimethyl-2-isopropylpentanoate, silver 2,5-dimethyl-2-ethylhexanoate, silver 2,2-diethylhexanoate, silver 2-butylhexanoate, or a combination thereof.

59. The method of claim 48, wherein the terpene is a purified terpene or the terpenoid is a purified terpenoid.

60. The method of claim 48, wherein the terpene is a pinene or a limonene.

61. The method of claim 48, wherein the terpenoid is a terpineol.

62. The method of claim 48, wherein the at least one dissolving agent comprises a limonene.

63. The method of claim 62, wherein the limonene is a purified limonene.

64. The method of claim 48, wherein the conductive ink composition further comprises at least one adhesion promoter.

65. The method of claim 64, wherein the at least one adhesion promoter comprises a reactive silane.

66. The method of claim 65, wherein the at least one adhesion promoter comprises an alkoxysilane.

67. The method of claim 66, wherein the at least one adhesion promoter comprises an ethoxysilyl modified polyalkene.

68. The method of claim 67, wherein the at least one adhesion promoter comprises a triethoxysilyl modified poly-1,2-butadiene.

69-79. (canceled)

80. The method of claim 48, wherein the conductive ink composition further comprises at least one acid stabilizer.

81. The method of claim 80, wherein the at least one acid stabilizer is a C₆-12 α-branched alkanoic acid.

82. The method of claim 81, wherein the at least one acid stabilizer is an α-branched decanoic acid isomer.

83. The method of claim 82, wherein the at least one acid stabilizer is 2,2-dimethylhexanoic acid or 2,2-dimethylnonanoic acid.

84. The method of claim 48, wherein the silver decanoate comprises at least one α-branched silver decanoate isomer, the at least one dissolving agent comprises a limonene, and wherein the conductive ink composition further comprises at least one adhesion promoter comprising a reactive silane.

85. The method of claim 84, wherein the conductive ink composition further comprises at least one acid stabilizer.

86. The method of claim 48, wherein the silver decanoate comprises at least one α-branched silver decanoate isomer, the at least one dissolving agent comprises a limonene, and wherein the conductive ink composition further comprises at least one acid stabilizer.

87. The method of claim 48, wherein the conductive ink composition has a concentration of about 1 to about 50 weight percent silver decanoate.

88. The method of claim 48, wherein the conductive ink composition has a viscosity from about 5 centipoise to about 50 centipoise.

89. The method of claim 48, wherein the conductive ink composition has a viscosity from about 50 centipoise to about 1000 centipoise.

90. The method of claim 48, wherein the silver decanoate is decarboxylated at a temperature of 180° C. or less to form a conductive structure.

91. The method of claim 48, wherein the silver decanoate is decarboxylated at a temperature of 150° C. or less to form a conductive structure.

92. A method of forming a conductive structure, comprising:
applying the conductive ink composition of any one of claims 1-36 to a substrate; and
heating the conductive ink composition on the substrate to a temperature of about 250° C. or less to form the conductive structure.

93. The method of claim 92, wherein the conductive ink composition is applied by slot die coating, spin coating, roll-to-roll printing, including gravure, flexography, rotary screen printing, screen printing, aerosol jet printing, inkjet printing, airbrushing, Mayer rod coating, flood coating, 3D printing, dispenser, or electrohydrodynamic printing.

94. The method of claim 92, wherein the conductive structure has a resistance of no more than 5 ohms per square, no more than 2 ohms per square, no more than 1 ohm per square, or no more than 0.5 ohms per square.

95. The method of claim 92, wherein the conductive structure has a bulk silver content of at least 1%.
